(19) United States
(12) Patent Application Publication
(10) Pub. No.: US 2004/0066452 A1
(43) Pub. Date: Apr. 8, 2004

(54) Vehicle security apparatus and method

(76) Inventor: Todd J. Gauthier, Chandler, AZ (US)

Correspondence Address: Robert A. Parsons, PARSONS & GOLTRY, Suite 260, 340 East Palm Lane, Phoenix, AZ, 85004, US

(21) Appl. No.: 10/365,355

(22) Filed: Feb. 12, 2003

Related U.S. Application Data
(60) Provisional application No. 60/415,918, filed on Oct. 3, 2002.

(51) Int. Cl. H04N 7/18

(52) U.S. Cl. 348/148; 340/937

(57) ABSTRACT

Vehicle security apparatus includes several mini cameras inconspicuously mounted in a vehicle so as to have a field of view of all entrances into the vehicle. A central processing unit (CPU) and software are connected to the cameras and inconspicuously mounted in the vehicle so as to activate the cameras in response to an activation signal. A memory is connected to the central processing unit and software to receive and store images from the cameras. An operator interface is coupled to the CPU and software to facilitate an operator entering data into the apparatus to control operation thereof. The operator interface also includes a monitor for reviewing stored images.

### CROSS-REFERENCE TO RELATED APPLICATION

This application claims the benefit of U.S. Provisional Application No. 60/415,918, filed Oct. 3, 2002.

### FIELD OF THE INVENTION

This invention relates to vehicle security apparatus including cameras mounted inconspicuously in the vehicle.

More specifically, the invention relates to cameras hidden in vehicles and systems for recording pictures of people breaking and entering the vehicles.

### BACKGROUND OF THE INVENTION

Vehicles, including automobiles of all types, trucks of all types, motor homes, travel trailers, boats of all types, airplanes, busses, etc., are the subject of crimes including theft, vandalism, etc. Not only is this a major crime problem, it is becoming worse as the number of vehicles, and people, becomes greater. Various studies of this problem have shown that in 86% of vehicle break-ins the vehicle is not stolen but simply vandalized. Further, 52% of apprehended perpetrators are known by the victims and can be quickly and easily identified if the victims can see them.

At the present time, many vehicles include alarm systems that make loud noises, flash lights, or otherwise attempt to attract attention when a break-in occurs. The problem is that these systems must rely on the presence of other people or, most unlikely, a policeman near the scene. Efficient criminals can break into an automobile and drive it off in a matter of seconds, sometimes even before people near the scene realize what is happening. Some security systems are now available to prevent the automobile from being started without a proper key or other device. However, vandalism is still a problem and even the breaking in causes damage that can be costly but must be repaired.

It would be highly advantageous, therefore, to remedy the foregoing and other deficiencies inherent in the prior art.

Accordingly, it is an object of the present invention to provide new and improved vehicle security apparatus.

Another object of the invention is to provide a new and improved vehicle security apparatus and a method of operation.

And another object of the invention is to provide a new and improved vehicle security apparatus that improves chances of identifying and catching vehicle thieves and vandals.

Still another object of the invention is to provide a new and improved vehicle security apparatus that can substantially reduce vehicle theft and vandalism.

### SUMMARY OF THE INVENTION

The above problems and others are at least partially solved and the above purposes and others realized in new and improved vehicle security apparatus including at least one mini camera designed to be inconspicuously mounted in a vehicle so as to have a field of view at least partially within the vehicle. A central processing unit (CPU) and software are connected to the camera or cameras and designed to be inconspicuously mounted in the vehicle for activating the camera in response to an activation signal. A memory is connected to the central processing unit and software for receiving and storing images from the camera. Upon activation, the camera or cameras take images within the vehicle of any perpetrators of crime that may be present and store the images in the memory.

The above problems and others are at least partially solved and the above purposes and others further realized in a new and improved method of securing a vehicle from external crime perpetrators including a step of providing vehicle security apparatus with at least one mini camera inconspicuously mounted in the vehicle so as to have a field of view at least partially within the vehicle, a central processing unit (CPU) and software connected to the at least one camera and inconspicuously mounted in the vehicle for activating the camera in response to an activation signal, a memory connected to the central processing unit and software for receiving and storing images from the camera, and an operator interface coupled to the central processing unit (CPU) and software for entering data into the apparatus to control operation thereof. The owner/operator arms the apparatus using the operator interface and subsequent to an activation incident views the stored images generally using the operator interface. The owner/operator then has the option of either deleting the stored images if a crime perpetrator is not involved or using the stored images when a crime perpetrator is involved to contact the authorities and identify the perpetrator.

### BRIEF DESCRIPTION OF THE DRAWINGS

The foregoing and further and more specific objects and advantages of the invention will become readily apparent to those skilled in the art from the following detailed description taken in conjunction with the drawings in which:

FIG. 1 is a simplified block diagram of vehicle security apparatus in accordance with the present invention;

FIG. 2 is a simplified plan view of the inside front (i.e. windshield, front panel, etc.) of a vehicle such as an automobile illustrating positions for various components of the vehicle security apparatus in accordance with the present invention;

FIG. 3 is a simplified top plan view of an automobile further illustrating positions for various components of the vehicle security apparatus in accordance with the present invention;

FIG. 4 is a simplified inside view of a vehicle door further illustrating a position for a component of the vehicle security apparatus in accordance with the present invention;

FIG. 5 is a simplified side view of a truck cargo space further illustrating a position for a component of the vehicle security apparatus in accordance with the present invention;

FIG. 6 is a flow diagram illustrating a method of operation of the vehicle security apparatus in accordance with the present invention; and

FIG. 7 is a flow diagram illustrating the method of operation of the vehicle security apparatus, including some options, in accordance with the present invention.

### DETAILED DESCRIPTION OF A PREFERRED EMBODIMENT

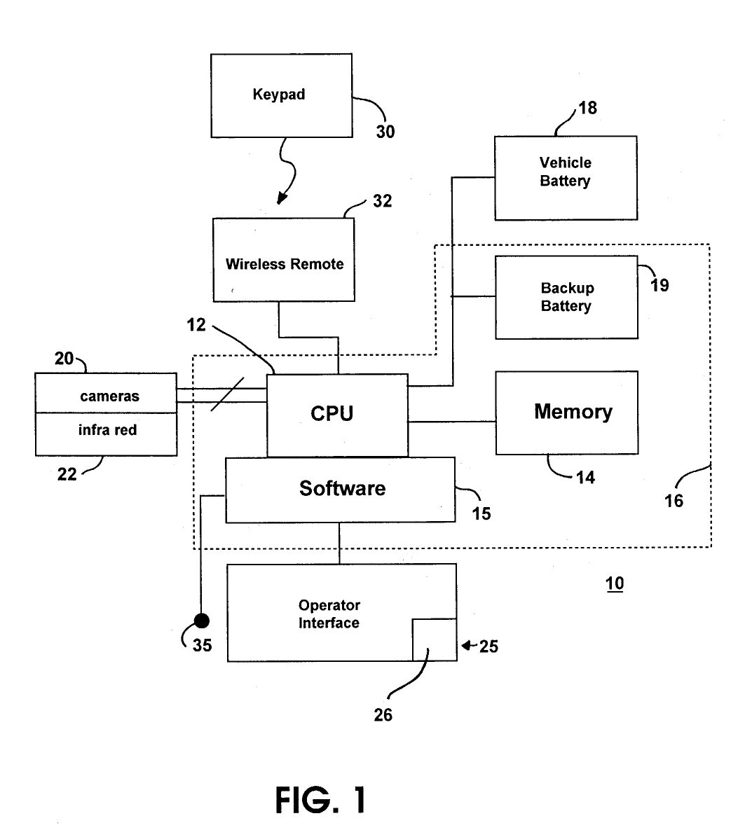

Turning to the drawings, in which like reference characters indicate corresponding elements throughout the several views, attention is first directed to FIG. 1, which illustrates vehicle security apparatus, generally designated 10, in accordance with the present invention. Apparatus 10 includes a Central Processing Unit (CPU) 12 with an associated memory 14 and software 15 designed to perform the various tasks to be described. As will be understood by those skilled in the art, memory 14 and software 15 can be in any of the well known forms compatible with the specific CPU utilized. In a preferred embodiment, memory 14 is any easily written and read device, such as a flash card memory similar to those used in digital cameras, but could include a hard drive (similar to that used in personal computers), a CD write unit, a magnetic tape recorder, a DVD burner, etc. Software 15 may be incorporated in circuitry associated with CPU 12 or, in some instances, may be incorporated into the CPU itself.

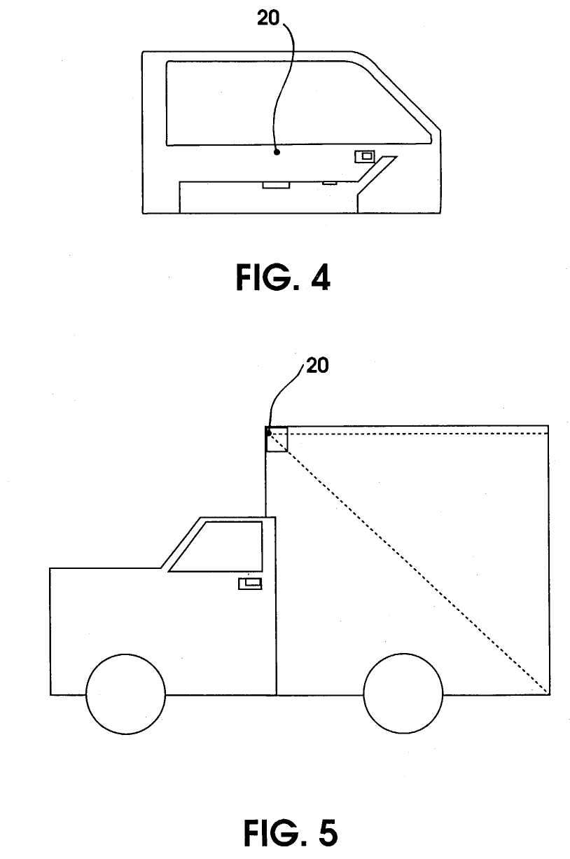

In a preferred embodiment, CPU 12, memory 14, and software 15 are fully enclosed within a housing and constitute a main unit, indicated by broken lines and generally designated 16, along with any other circuitry that may be required to perform the functions to be described. Main unit 16 may have small fans or any other cooling or heat dissipation devices required and will generally be heat and weather resistant. In the preferred embodiment, apparatus 10 will normally receive power from the vehicle battery 18, or other vehicle power source, but will generally have a backup battery 19 for use in case of vehicle power failure due to a dead vehicle battery, wires being cut, etc. Backup battery 19 will generally be contained within (or immediately adjacent) main unit 16 for convenience and safety. Further, main unit 16 is mounted on the vehicle to be protected in an inconspicuous position, such as in the trunk, under the chassis, in the engine compartment, etc. Referring additionally to FIG. 3, two possible mounting positions for main unit 16 are illustrated.

One or more cameras 20 are connected to CPU 12 for appropriate operation and storage in memory 14 of pictures taken. Cameras 20 are preferably small micro cameras that can be mounted inconspicuously almost anywhere in the vehicle. Micro cameras can be typically about the size of a dime and in some instances may be much smaller (e.g. the cameras inserted in the body for use in some medical operations). When cameras 20 include more than one camera, software 15 programs CPU 12 to operate the cameras in some sort of pattern to ensure the best visual coverage of the vehicle to be protected. Generally, in the use of more than one camera they will be staggered and synchronized so that all shots can be recorded on the memory, such as a flash card. In some specific instances a memory may be provided in association with each camera but generally, for economical and convenience reasons a single memory unit will serve all cameras. Further, in the preferred embodiment, cameras 20 have an associated infrared lighting system 22 to provide inconspicuous lighting for suitable image capture. Here it will be understood that memory 14 can be connected to store sounds as well as pictures, if desired.

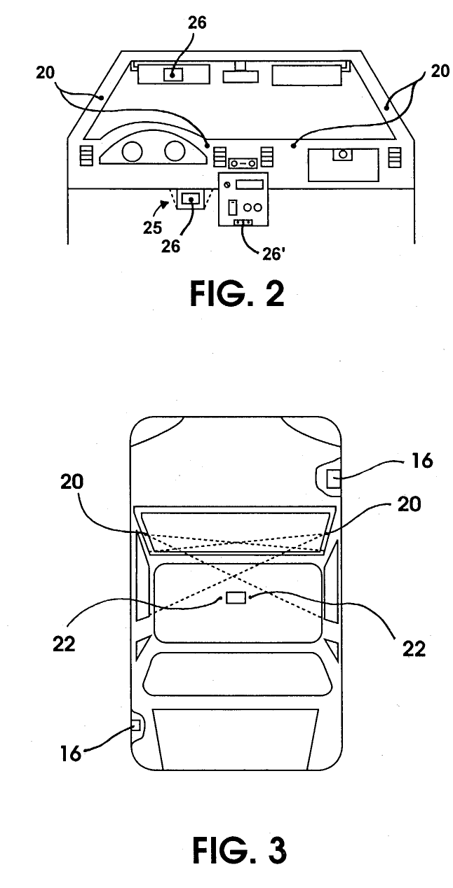

An operator interface, generally designated 25, is mounted at some convenient position, preferably within the vehicle and generally includes a small viewing screen 26 and some associated controls. As an example, viewing screen 26 can be an LCD, TFT, or electroluminescent screen and can be mounted under the dashboard of an automobile so as to flip down for viewing or mounted in a sun visor under a mirror cover, as illustrated in FIG. 2. Viewing screen 26 is used to view pictures taken by cameras 20 and stored in memory 14, as well as text and graphical feedback such as images cleared, space left on memory 14, battery charge remaining, etc. It can also be used in conjunction with the associated controls to change camera time intervals, etc. Operator interface 25 could include, in addition to viewing screen 26 or as a less expensive alternative, LED lights 26′ (see FIG. 2) that through a combination of colors and operation advise an operator of a situation. For example, constant amber means the memory is full, flashing amber means the battery charge is low, constant red means apparatus 10 is armed not currently taking pictures, flashing red means apparatus 10 is armed and currently taking pictures, etc.

Referring additionally to FIGS. 2 and 3, as an example of a possible mounting location, cameras 20 can be mounted in the roof posts on each side of the windshield and directed to cover both front doors of the vehicle. Additionally, or in lieu of, cameras can be mounted in the dashboard and directed generally rearwardly and to the side to cover the front doors and the front seat. Infrared lights 22 can be mounted, for example, in the roof adjacent the standard roof light, as shown in FIG. 3. Additionally, or in lieu of the above described positions, cameras 20 can be mounted in the doors, as illustrated in FIG. 4, to cover either the front or rear seats, the opposite door, and anyone stepping through the door on which the camera is mounted. To cover the cargo space of trucks and the like, cameras 20 can be mounted in an upper corner of the body and directed toward a rear opening door, as illustrated in FIG. 5.

A keypad 30 is provided to control operator interface 25 and CPU 12. Keypad 30 could be a small calculator type control board inconspicuously mounted in the door of the vehicle being protected, the console, glove compartment, etc. In a preferred embodiment, keypad 30 includes a small wireless remote control transmitter that communicates with a receiver in wireless remote 32 by RF, infrared, etc. Generally, wireless remote 32 is provided as a separate unit and may be, for example, compatible with other wireless electronic units, such as a Palm Pilot™ utilizing downloaded software to control all functionality, cell phones, etc. Additionally, remote 32 can be a remote device from an existing security system integrated into apparatus 10. Also wireless remote 32 may include some means of transmission for purposes to be described presently. Further, keypad 30 can be fixedly mounted on or in the vehicle or can be removably mounted for use as a remote control unit. Keypad 30 is used for functions such as changing a pass code, entering a pass code before deleting images, changing camera time intervals and duration, etc. Keypad 30 also includes function buttons for viewing images, deleting images, receiving indications of remaining image storage space and battery life, etc.

Here it will be understood by those skilled in the art that viewing screen 26 can be a touch screen, which can be used in lieu of or in addition to keyboard 30. It will be understood that a touch screen interface can be used in order to eliminate keyboard 30 and much more functionality would be available. In this example the removable portion of the interface would include viewing screen 26 and some or all of the function buttons.

In a preferred embodiment, CPU 12 and software 15 can be connected into an existing alarm system in the vehicle, by means of an input terminal 35. In this specific embodiment, vehicle security apparatus 10 is activated upon the existing alarm system being activated. Using cameras 20, apparatus 10 will take and record images to memory 14 as previously configured by the operator. In other modes of operation, apparatus 10 can be activated by a remote control or toggle switch that just activates vehicle security apparatus 10 to capture images without activating the existing alarm system. In yet another mode of operation, upon failure of the main power source (e.g. the vehicle battery) backup battery 19 will automatically provide power to apparatus 10, activate cameras 20 and start capturing images at a pre-designated rate as previously defined by the operator (e.g. 1 sec, 5 sec, 1 min, etc.). In at least one design of vehicle security apparatus 10, images are sent to a remote server utilizing a wireless communication system, such as a transmitter in wireless remote 32, wireless telephones, cell phones, etc.

Thus, main unit 16 is tamper resistant and mounted inconspicuously so as to create a bigger obstacle to thieves and the like than is worth breaking into the vehicle in the first place. Mini-cameras 20 are mounted anywhere, viewing all entry points, giving cameras 20 more time to “capture” the perpetrator before possibly being dismantled in any way. Wires connecting various components of apparatus 10 are run through or encased in Romex™ steel, channel steel, portions of the vehicle body, or some other tamper resistant medium. Any further precautions, such as making the area around memory 14 fire resistant, may be included if desired.

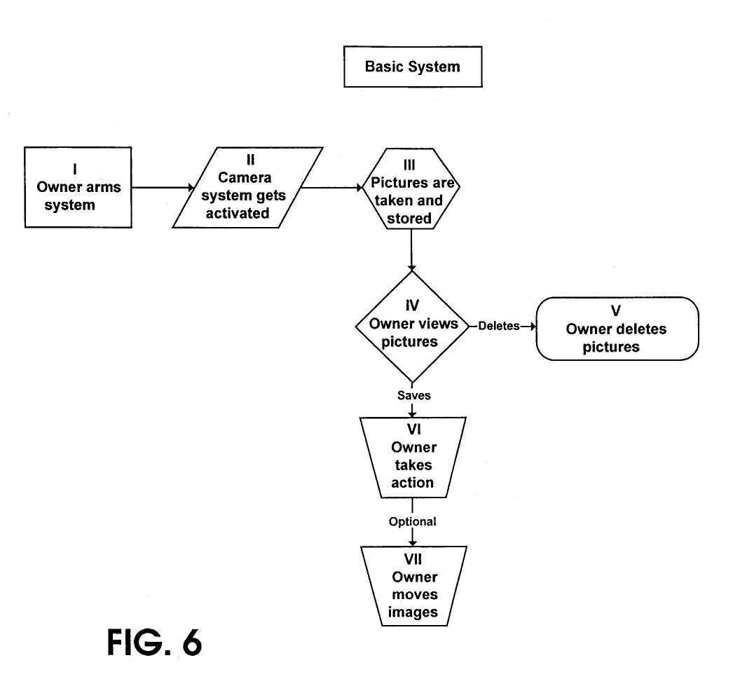

Turning now to FIG. 6, a flow diagram is provided, illustrating one method of operation of vehicle security apparatus 10 in accordance with the present invention. In an initial step (step I), vehicle security apparatus 10 is armed. This arming may occur in several different ways, depending upon the specific system and the application. For example, apparatus 10 may be connected to an existing vehicle alarm system and may be armed by operation of that existing system. Vehicle security apparatus 10 will also be able to be armed as a stand alone system, separate from any existing alarm system, by a push button remote control (e.g. a cell phone, etc.) or by entering a pass code on operator interface 25.

With vehicle security apparatus 10 armed, activation can (step II) occur in a variety of different ways. For example, if apparatus 10 is connected into an existing vehicle alarm system and is activated when the existing system is activated, when the existing alarm system goes off, cameras 20 will be activated and start capturing images, which are stored in memory 14. The images may also be transmitted directly to a remote server. In another mode, vehicle security apparatus 10 is programmed to be activated by interruption of power from the vehicle power source, e.g. vehicle battery 18. In this mode power to vehicle security apparatus 10 is supplied by backup battery 19, which automatically activates cameras 20 to start capturing images. In another mode, vehicle security apparatus 10 is programmed to be activated by the owner using keypad 30 or a remote control unit, such as a cell phone or the like.

In the third step (step III), after activation any number of mini cameras 20 take pictures that are sent to memory 14. The pictures may include date and time stamps, provided by CPU 12, if desired. The operating intervals and duration of each camera 20 are preset into apparatus 10 by the owner, using operator interface 25. Software 15 automatically staggers the camera action according to the time settings so images from all cameras 20 will be captured and stored in memory 14. Software 15 may be programmed to monitor differences in images and only save the ones that are different enough according to pre-configured settings by the owner.

In a fourth step (step IV), the owner enters the pass code and views the stored images on viewing screen 26. At this point the owner has two alternatives, depending upon the circumstances. The owner may delete all or individual unneeded images in step V to free up room in memory 14. Generally, this will occur when no thief or vandal was involved. At this point vehicle security apparatus 10 is generally returned to step I. As an alternative (step VI), the owner may retain the images and take some appropriate action, such as notifying a law enforcement agency and/or the owner's insurance company. As an option (step VII), memory 14 may include a removable nonvolatile portion that the owner can remove from apparatus 10 to transfer images and audio (if included) to a safer media storage device (e.g. a personal computer), and also to view, archive, or hardcopy the data.

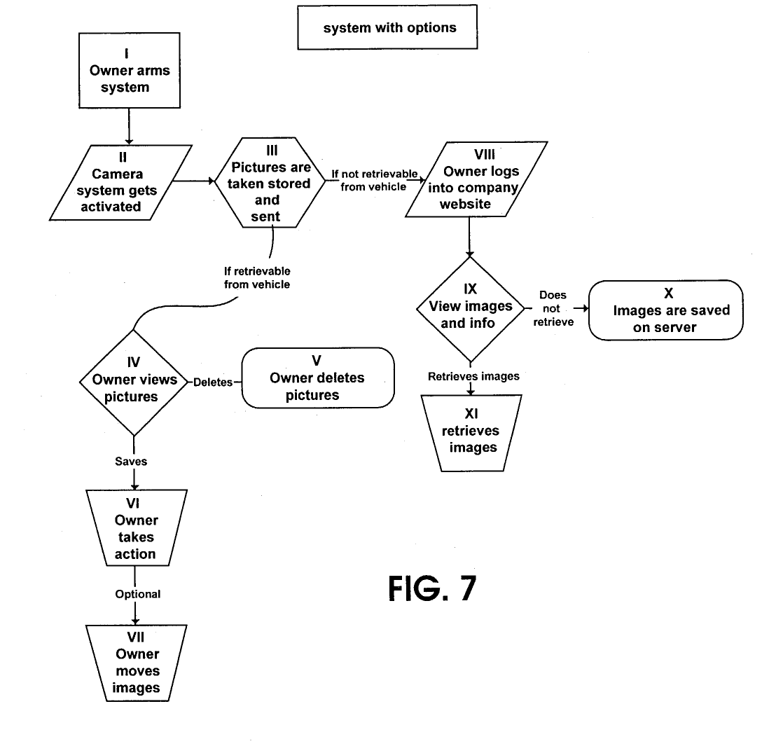

Referring additionally to FIG. 7, a flow diagram is provided, illustrating the above described method of operation of vehicle security apparatus 10 with some additional options in accordance with the present invention. In step I, vehicle security apparatus 10 is armed as described above and in step II apparatus 10 is activated as described above. In step III, images or pictures are taken and stored, as described above and the images are transmitted to a remote secure server for storage. If the images are also retrievable from the vehicle, steps IV through VII may be followed. If the images are not retrievable from the vehicle a step VIII is performed in which the owner logs onto a website of the server with the owner's name and password. In a step IX, the owner reviews the images and any other data to determine whether or not to retrieve the images. At this point the owner can also update or change any personal information, such as the password, name, Email address, etc. If the owner decides not to retrieve the images (step X), the images are saved on the server some predetermined period of time. If the owner decides to retrieve the images (step XI), they may be downloaded directly or sent to the owner's Email address stored in the server database.

Thus a new and improved vehicle security system and method are disclosed that can provide substantial aid in catching and/or stopping thieves and vandals and that will, therefore, substantially reduce vehicle theft and vandalism.

The new and improved vehicle security system and method improves chances of identifying and catching vehicle thieves and vandals because images of the thieves and vandals are taken and stored in the security apparatus for later identification and/or sent directly to a remote server and stored. Further, the new and improved vehicle security system is installed in the vehicle so as to be virtually tamper resistant and, in most instances, the thieves or vandals will not even be aware that they are being photographed.

The invention has been described above with reference to one or more preferred embodiments. However, those skilled in the art will recognize that changes and modifications may be made in the described embodiments without departing from the nature and scope of the invention. For instance, a remote server may be incorporated into the system and process or the system may be incorporated directly into an existing vehicle alarm system.

Various changes and modifications to one or more of the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. Vehicle security apparatus comprising:
at least one mini camera designed to be inconspicuously mounted in a vehicle so as to have a field of view at least partially within the vehicle;
a central processing unit (CPU) and software connected to the at least one camera and designed to be inconspicuously mounted in the vehicle for activating the camera in response to an activation signal; and
a memory connected to the central processing unit and software for receiving and storing images from the camera.

2. Vehicle security apparatus as claimed in claim 1 further including an operator interface coupled to the central processing unit (CPU) and software for entering data into the apparatus to control operation thereof.

3. Vehicle security apparatus as claimed in claim 2 wherein the operator interface includes a system of colored and blinking lights designed to provide an indication of the status of the apparatus.

4. Vehicle security apparatus as claimed in claim 2 wherein the operator interface includes a monitor for viewing stored images and entering data.

5. Vehicle security apparatus as claimed in claim 4 wherein the monitor includes a touch screen for entering data.

6. Vehicle security apparatus as claimed in claim 1 further including a wireless remote unit coupled to the central processing unit (CPU) and software for controlling the apparatus remotely.

7. Vehicle security apparatus as claimed in claim 6 wherein the wireless remote unit includes a wireless transmitter for transmitting stored images to a remote site.

8. Vehicle security apparatus as claimed in claim 1 further including an infrared lighting system coupled to the central processing unit (CPU) and software and activated in response to the activation signal for providing illumination within the vehicle.

9. Vehicle security apparatus as claimed in claim 1 further including a power lead for connection to a battery of the vehicle and a backup battery for supplying power if the vehicle battery fails.

10. Vehicle security apparatus comprising:
at least one mini camera inconspicuously mounted in a vehicle so as to have a field of view at least partially within the vehicle;
a central processing unit (CPU) and software connected to the at least one camera and inconspicuously mounted in the vehicle for activating the camera in response to an activation signal;
a memory connected to the central processing unit and software for receiving and storing images from the camera; and
an operator interface coupled to the central processing unit (CPU) and software for entering data into the apparatus to control operation thereof.

11. Vehicle security apparatus as claimed in claim 10 wherein the at least one mini camera includes a plurality of mini cameras inconspicuously mounted in the vehicle so as to view all entrances.

12. Vehicle security apparatus as claimed in claim 10 wherein the apparatus is coupled to an existing alarm system in the vehicle for providing the activation signal of the apparatus upon activation of the existing alarm system.

13. Vehicle security apparatus as claimed in claim 10 wherein the operator interface includes a monitor for viewing stored images and entering data.

14. Vehicle security apparatus as claimed in claim 13 wherein the monitor includes a touch screen for entering data.

15. Vehicle security apparatus as claimed in claim 10 further including a wireless remote unit coupled to the central processing unit (CPU) and software for controlling the apparatus remotely.

16. Vehicle security apparatus as claimed in claim 15 wherein the wireless remote unit includes a wireless transmitter for transmitting stored images to a remote site.

17. Vehicle security apparatus as claimed in claim 10 further including an infrared lighting system coupled to the central processing unit (CPU) and software and activated in response to the activation signal for providing illumination within the vehicle.

18. Vehicle security apparatus as claimed in claim 10 further including a power lead connected to a battery of the vehicle and a backup battery for supplying power if the vehicle battery fails.

19. Vehicle security apparatus as claimed in claim 18 wherein the central processing unit (CPU) and software are programmed to receive an activation signal when the vehicle battery fails.

20. A method of securing a vehicle from external crime perpetrators comprising the steps of:
providing vehicle security apparatus including at least one mini camera inconspicuously mounted in the vehicle so as to have a field of view at least partially within the vehicle, a central processing unit (CPU) and software connected to the at least one camera and inconspicuously mounted in the vehicle for activating the camera in response to an activation signal, a memory connected to the central processing unit and software for receiving and storing images from the camera, and an operator interface coupled to the central processing unit (CPU) and software for entering data into the apparatus to control operation thereof;
arming the apparatus using the operator interface; and
viewing stored images, using the operator interface, and one of deleting the stored images if a crime perpetrator is not involved and using the stored images when a crime perpetrator is involved to identify the perpetrator.
